(19) United States
(12) Patent Application Publication
(10) Pub. No.: US 2025/0020005 A1
(43) Pub. Date: Jan. 16, 2025

(54) Aircraft latch Assembly with Lock Sensor(s)

(71) Applicant: Rohr, Inc., Chula Vista, CA (US)

(72) Inventors: Sangareddy CHALLAMREDDY, Bidar (IN); Shashidhar SHIVARUDRAPPA, Bangalore (IN)

(21) Appl. No.: 18/402,352

(22) Filed: Jan. 2, 2024

(30) Foreign Application Priority Data
Jan. 2, 2023 (IN) 202311000143

(51) Int. Cl. E05C 3/08; B64D 29/06; E05B 13/00; E05B 41/00; E05C 3/00

(52) U.S. Cl. CPC E05C 3/08; B64D 29/06; E05B 13/002; E05B 41/00; E05C 3/008

(57) ABSTRACT

An assembly is provided for an aircraft. This assembly includes a keeper, a latch, a lock and an electric sensor. The latch includes a handle and a hook structure operatively coupled to the handle. The hook structure is engaged with the keeper when the handle is in a closed position. The hook structure is disengaged from the keeper when the handle is in an open position. The lock includes a lock element configured to move between a locked position and an unlocked position. The lock is configured to lock the handle in the closed position when the lock element is in the locked position. The lock is configured to unlock the handle from the closed position when the lock element is in the unlocked position. The electronic sensor is configured to provide a signal when the lock element is in one of the locked position or the unlocked position.

This application claims priority to Indian Patent Appln. No. 202311000143 filed Jan. 2, 2023, which is hereby incorporated herein by reference in its entirety.

### BACKGROUND

### 1. Technical Field

This disclosure relates generally to a latch assembly for a structure such as, for example, an aircraft cowl.

### 2. Background Information

A modern aircraft propulsion system typically includes a gas turbine engine and a nacelle housing and providing an aerodynamic covering for the gas turbine engine. The nacelle may include one or more cowls for covering components of the gas turbine engine. These cowls may be pivotally mounted to a stationary structure enabling those cowls to be opened for providing access to the components underneath. The cowls may be secured in a closed position using one or more latch assemblies. Various types and configurations of latch assemblies are known in the art. While these known latch assemblies have various benefits, there is still room in the art for improvement.

### SUMMARY OF THE DISCLOSURE

According to an aspect of the present disclosure, an assembly is provided for an aircraft. This assembly includes a keeper, a latch, a lock and an electric sensor. The latch includes a handle and a hook structure operatively coupled to the handle. The handle is configured to move between a closed position and an open position. The hook structure is engaged with the keeper when the handle is in the closed position. The hook structure is disengaged from the keeper when the handle is in the open position. The lock includes a lock element configured to move between a locked position and an unlocked position. The lock is configured to lock the handle in the closed position when the lock element is in the locked position. The lock is configured to unlock the handle from the closed position when the lock element is in the unlocked position. The electronic sensor is configured to provide a signal when the lock element is in one of the locked position or the unlocked position.

According to another aspect of the present disclosure, another assembly is provided for an aircraft. This assembly includes a keeper, a latch, a lock and a rotary sensor. The latch includes a handle and a hook structure operatively coupled to the handle. The handle is configured to move between a closed position and an open position. The hook structure is engaged with the keeper when the handle is in the closed position. The hook structure is disengaged from the keeper when the handle is in the open position. The lock includes a lock element configured to move between a locked position and an unlocked position. The lock is configured to lock the latch when the lock element is in the locked position. The lock is configured to unlock the latch when the lock element is in the unlocked position. The rotary sensor is configured to provide a signal when the lock element is in one of the locked position or the unlocked position.

According to still another aspect of the present disclosure, another assembly is provided for an aircraft. This assembly includes a keeper, a latch, a lock and a proximity sensor. The latch includes a handle and a hook structure operatively coupled to the handle. The handle is configured to move between a closed position and an open position. The hook structure is engaged with the keeper when the handle is in the closed position. The hook structure is disengaged from the keeper when the handle is in the open position. The lock includes a lock element configured to move between a locked position and an unlocked position. The lock is configured to lock the latch when the lock element is in the locked position. The lock is configured to unlock the latch when the lock element is in the unlocked position. The proximity sensor is configured to provide a signal when the lock element is in one of the locked position or the unlocked position.

The assembly may also include a second sensor configured to provide a second signal when the lock element is in one of the locked position or the unlocked position.

The electronic sensor may be configured to provide the signal when the lock element is in the locked position.

The electronic sensor may be configured to provide the signal when the lock element is in the unlocked position.

The electronic sensor may be configured as or otherwise include a rotary sensor.

The electronic sensor may be configured as or otherwise include a proximity sensor.

The assembly may also include a second electronic sensor configured to provide a second signal when the lock element is in one of the locked position or the unlocked position.

The electronic sensor and the second electronic sensor may be different types of sensors.

The electronic sensor may be configured as or otherwise include a rotary sensor. The second electronic sensor may be configured as or otherwise include a proximity sensor.

The assembly may also include a user interface configured to present an indicator when the electronic sensor provides the signal.

The lock element may be configured as or otherwise include a lever.

The lock may also include a catch. The lock element may be aligned with the catch locking the handle in the closed position when the lock element is in the locked position. The lock element may be misaligned from the catch unlocking the handle from the closed position when the lock element is in the unlocked position.

The lock element may be configured to rotate about a lock element axis between the locked position and the unlocked position.

The assembly may also include a fitting adjacent the handle. The lock may also include a bolt rotatably mounted to the fitting. The lock element may be rotationally fixed to the bolt.

The latch may be configured to pivot about a latch axis between the closed position and the open position. The latch axis may be angularly offset from the lock element axis.

The latch may be configured to pivot about a latch axis between the closed position and the open position. The latch axis may be parallel with the lock element axis.

The handle may extend longitudinally between a first end and a second end. The lock may be arranged at the first end.

The assembly may also include a fixed structure, a first aircraft component and a second aircraft component. The first aircraft component may be pivotally attached to the fixed structure. The latch may be mounted to the first aircraft component. The second aircraft component may be pivotally attached to the fixed structure. The keeper may be mounted to the second aircraft component.

The assembly may also include a fitting adjacent the handle. The fitting may include a land. The lock also includes a catch. The lock element may extend between a first end and a second end. The lock element may be configured to engage the catch at the first end and the lock element may be configured to engage the land at the second end when the lock is in the locked position. The lock element may be configured to pivot about an axis moving the first end inwards and moving the second end outwards when the lock is moved from the locked position to the unlocked position. The catch may be configured to move past the lock element facilitating opening of the latch when the lock is in the unlocked position.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial side sectional illustration of an aircraft assembly.

FIG. 2 is a side illustration of an aircraft propulsion system.

FIG. 3 is a schematic cross-sectional illustration of the aircraft propulsion system with its cowls in closed positions.

FIG. 4 is a schematic cross-sectional illustration of the aircraft propulsion system with its cowls in open positions.

FIG. 5 is a partial sectional illustration of the aircraft assembly with its latch in an open position.

FIG. 6 is a partial schematic sectional illustration of a portion of the latch assembly with a lock in a locked position.

FIG. 7 is a partial perspective illustration of a portion of the latch assembly with its lock in the locked position.

FIGS. 8 and 9 are perspective illustrations of a latch assembly shown without its keeper or its lock for ease of illustration.

FIGS. 10A and 10B are schematic sectional illustrations of a portion of the latch assembly with a handle release device in various positions.

FIGS. 11A and 11B are partial perspective illustrations of a portion of the latch assembly with its lock in various positions.

FIGS. 12A and 12B are partial perspective illustrations of a portion of the latch assembly with its lock in various positions and a monitoring system with a lock sensor.

FIGS. 13A and 13B are partial perspective illustrations of a portion of the latch assembly with its lock in various positions and another lock sensor.

FIG. 14 is a partial perspective illustration of a portion of the latch assembly with multiple lock sensors.

FIG. 15 is a partial perspective illustration of a portion of the latch assembly with another lock.

### DETAILED DESCRIPTION

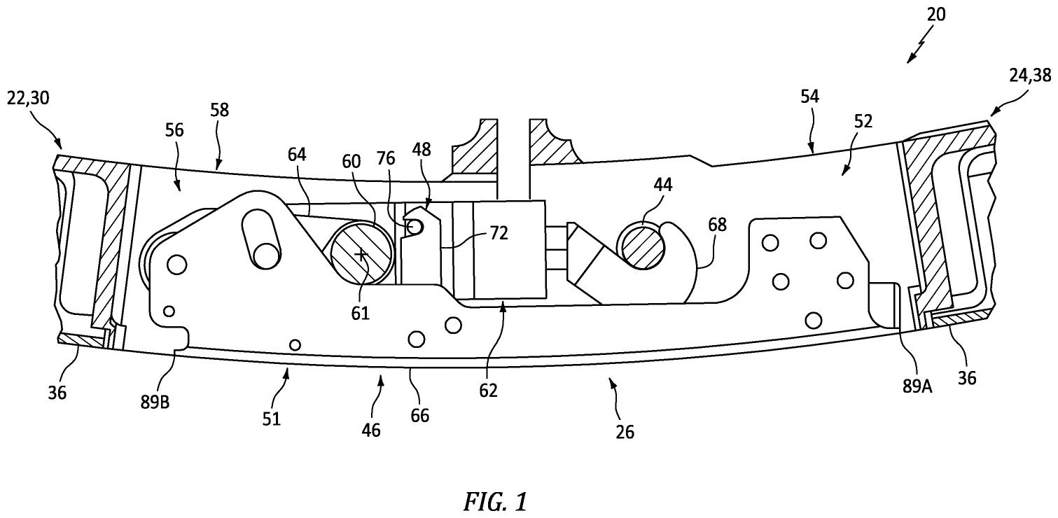

FIG. 1 illustrates an assembly 20 for an aircraft structure. An example of the aircraft structure is a nacelle for an aircraft propulsion system, where the nacelle houses an aircraft propulsion system powerplant such as, but not limited to, a gas turbine engine. Another example of the aircraft structure is an aircraft fuselage. The assembly 20 of the present disclosure, however, is not limited to the foregoing exemplary aircraft structures. The assembly 20 of FIG. 1 includes one or more aircraft components 22 and 24 and a latch assembly 26.

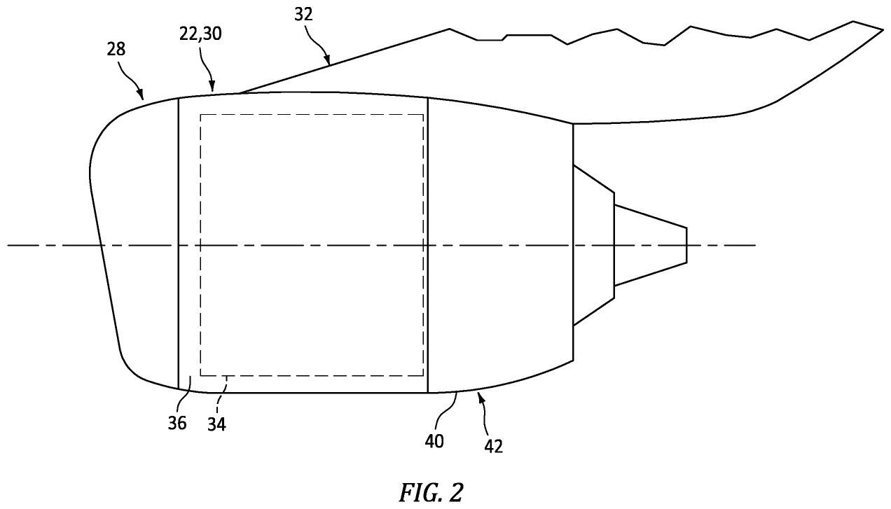

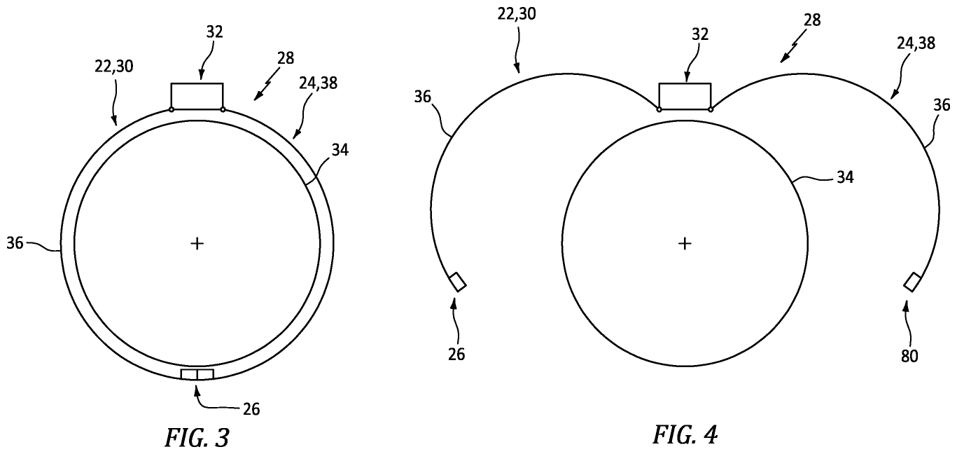

Referring to FIGS. 2-4, the first component 22 may be configured as part of an outer nacelle structure 28 for the aircraft propulsion system nacelle. The first component 22 of FIGS. 2-4, for example, may be configured as or otherwise include a first fan cowl 30 of the outer nacelle structure 28. This first fan cowl 30 is movably (e.g., pivotally) connected to a stationary structure 32 of the aircraft; e.g., a pylon structure for the aircraft propulsion system. The first fan cowl 30 is configured to move (e.g., pivot) between a fully closed position (e.g., see FIGS. 2 and 3) and a fully open position (e.g., see FIG. 4). In the closed position of FIG. 3, the first fan cowl 30 is configured to house and provide a first side aerodynamic covering for a fan case 34 for the powerplant. The first fan cowl 30 also partially forms an exterior aerodynamic surface 36 of the aircraft propulsion system nacelle.

The second component 24 may be configured as part of the outer nacelle structure 28. The second component 24 of FIGS. 3 and 4, for example, may be configured as or otherwise include a second fan cowl 38 of the outer nacelle structure 28, which second fan cowl 38 is arranged opposite the first fan cowl 30. This second fan cowl 38 is movably (e.g., pivotally) connected to the stationary structure 32. The second fan cowl 38 is configured to move (e.g., pivot) between a fully closed position (e.g., see FIG. 3) and a fully open position (e.g., see FIG. 4). In the closed position of FIG. 3, the second fan cowl 38 is configured to house and provide a second side aerodynamic covering for the fan case 34. The second fan cowl 38 also further forms the exterior aerodynamic surface 36 of the aircraft propulsion system nacelle.

The aircraft components 22 and 24 may be described herein as the fan cowls 30 and 38 for ease of description. It should be recognized, however, the latch assembly 26 may be configured with other components of the aircraft propulsion system or the aircraft fuselage. For example, referring to FIG. 2, each aircraft component 22, 24 may alternatively be configured as a respective section 40 (e.g., half; one visible in FIG. 2) of a thrust reverser 42, where the thrust reverser section 40 may be movably (e.g., pivotally) attached to the stationary structure 32 or another structure in a similar manner as described above with respect to the respective fan cowl 30, 38. The present disclosure therefore is not limited to any particular aircraft component configurations. Furthermore, while both aircraft components 22 and 24 are described as movable (e.g., pivotable) structures, it is contemplated one of the aircraft components 22, 24 may alternatively be configured as a fixed structure of the aircraft.

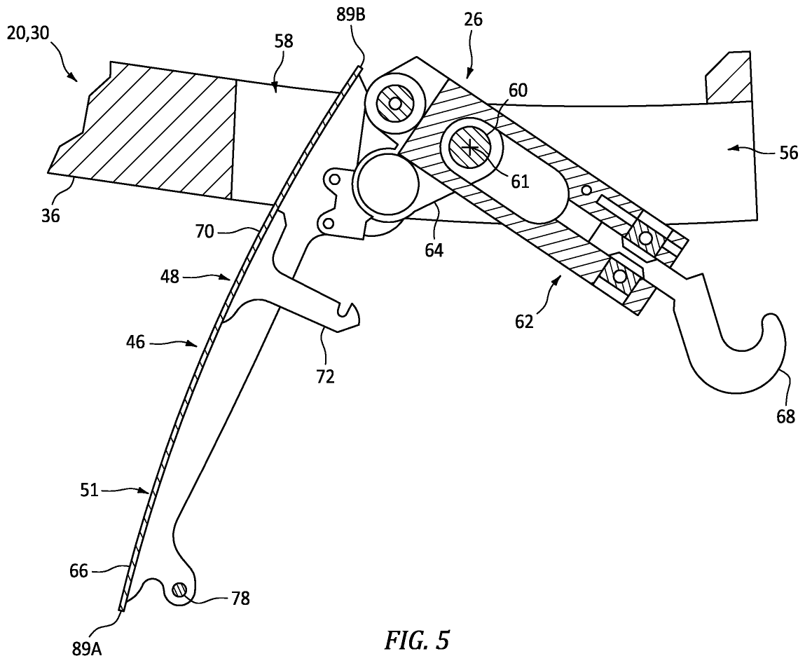

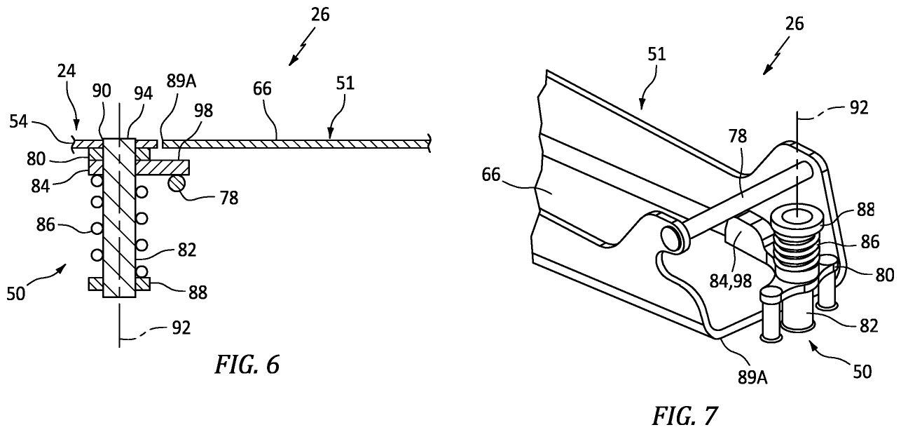

Referring again to FIG. 1, the latch assembly 26 is arranged at an interface between the first component 22 and the second component 24. The latch assembly 26 is configured to lock the (e.g., closed) aircraft components 22 and 24 together when the latch assembly 26 is closed/locked. The latch assembly 26 may thereby secure the first component 22 to the second component 24 when the latch assembly 26 is closed/locked. The latch assembly 26 is also configured to unlock the (e.g., closed) aircraft components 22 and 24 when the latch assembly 26 is open/unlocked. The latch assembly 26 may thereby enable movement of the first component 22 relative to the second component 24 (e.g., pivoting open each aircraft component 22, 24) when the latch assembly 26 is open/unlocked; e.g., see FIG. 5. The latch assembly 26 of FIG. 1 includes a keeper 44, a latch 46, a handle release device 48 and a lock 50 (see FIGS. 6 and 7). Briefly, the handle release device 48 of FIGS. 1 and 5 may operate as a primary lock for a handle 51 of the latch 46. The lock 50 of FIGS. 6 and 7 may operate as a secondary lock for the handle 51 and/or a lock for the handle release device 48.

The keeper 44 of FIG. 1 is (e.g., fixedly) mounted to the second component 24. The keeper 44, for example, may be disposed within and extend across a channel 52 in a fitting 54 of the second component 24. Each end of the keeper 44 may be connected to a respective side (e.g., flange, wall, etc.) of the second component fitting 54. The keeper 44 may be configured as a pin, a rod, a fastener or any other elongated body that may mate with the latch 46 as described below.

The latch 46 is (e.g., movably) mounted to the first component 22. The latch 46, for example, may be disposed within a channel 56 in a fitting 58 of the first component 22. A latch pin 60 may extend through at least one component of the latch 46 and across the channel 56 in the first component fitting 58. Each end of the latch pin 60 may be connected to a respective side (e.g., flange, wall, etc.) of the first component fitting 58. The latch pin 60 may form a latch axis 61 (e.g., a pivot axis) about which the latch 46 may pivot and move between its closed/locked arrangement (e.g., see FIG. 1) and its open/unlocked arrangement (e.g., see FIG. 5).

The latch 46 of FIG. 1 includes the handle 51 and a hook structure 62. The latch 46 may also include an intermediate linkage 64 operatively coupling the handle 51 to the hook structure 62. Of course, in other embodiments, it is contemplated the handle 51 may be directly operatively coupled to the hook structure 62 or alternatively multiple intermediate linkages may operatively couple the handle 51 to the hook structure 62.

The handle 51 is configured to move between a fully closed position (e.g., see FIG. 1) and a fully open position (e.g., see FIG. 5). In the closed position of FIG. 1, the latch 46 and its members 51, 62 and 64 may be disposed within the fitting channels 52 and 56 and a base 66 of the handle 51 may be flush with the exterior aerodynamic surface 36. The hook structure 62 may also engage the keeper 44. More particularly, a hook 68 at a distal end of the hook structure 62 may latch onto (e.g., grasp, partially wrap around and contact, etc.) the keeper 44. With this closed/locked latch assembly arrangement, the latch 46 may be locked onto the keeper 44 and the latch assembly 26 may maintain/secure the aircraft components 22 and 24 in their closed positions. By contrast, in the open position of FIG. 5, the latch 46 and its members 51, 62 and 64 may project out from the first fitting channel 56 and the handle base 66 may be angularly offset from the exterior aerodynamic surface 36. The hook structure 62 may also be disengaged from the keeper 44 (see FIG. 1). More particularly, the hook 68 may no longer latch onto and/or contact the keeper 44 (see FIG. 1). With this open/unlocked latch assembly arrangement, the latch 46 may be unlocked from the keeper 44 allowing the aircraft components 22 and 24 to move relative to one another; e.g., allowing pivoting open of one or more of the aircraft components 22 and 24.

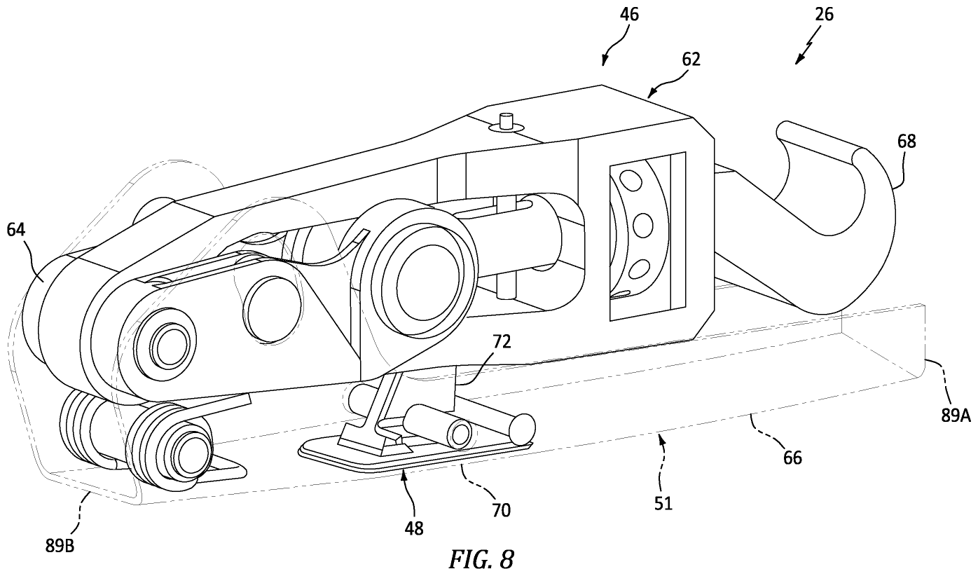

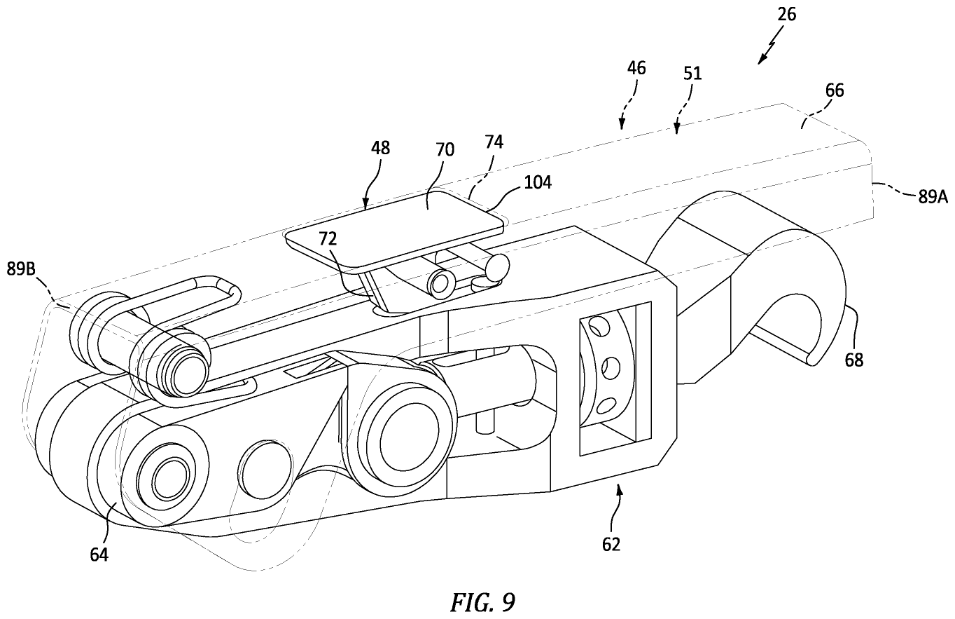

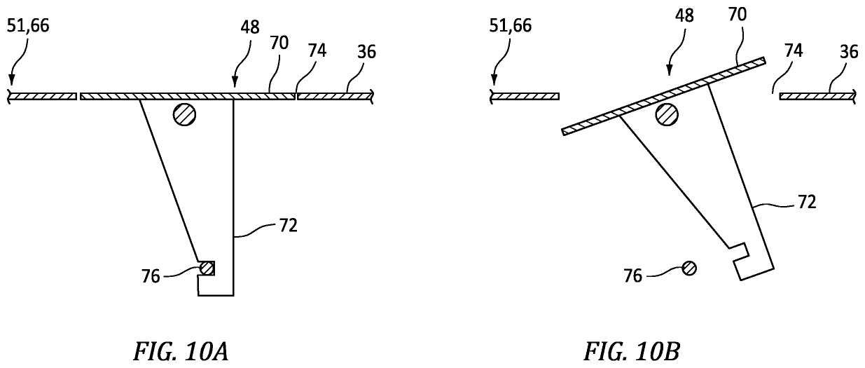

Referring to FIGS. 8 and 9, the handle release device 48 is movably (e.g., pivotally) connected to the latch 46. The handle release device 48, for example, includes a push button 70 (e.g., a planar panel) and a device latch 72. The device latch 72 is connected to and projects out from the push button 70. This device latch 72 may be pivotally connected to sidewalls of the handle 51 by a pin connection. With this arrangement, the handle release device 48 may move (e.g., pivot) between a first (e.g., locked) position (e.g., see FIG. 10A) and a second (e.g., unlocked) position (e.g., see FIG. 10B). In the first position of FIGS. 10A, the push button 70 may be seated in an aperture 74 (e.g., a port) through the handle base 66. The push button 70 may be flush with the exterior aerodynamic surface 36 and/or the handle base 66. The push button 70 may thereby be in an undepressed position. Here, the device latch 72 may engage (e.g., latch onto) a device keeper 76 on the latch 46; e.g., on the hook structure 62 of FIG. 1. With the handle release device 48 in its first position, the handle release device 48 may lock (e.g., secure) the handle 51 in its closed position. By contrast, in the second position of FIG. 10B, the push button 70 may project into the handle 51 and the push button 70 may be angularly offset from the handle base 66 and/or the exterior aerodynamic surface 36. The push button 70 may thereby be in a depressed position. Here, the device latch 72 may disengage (e.g., release) the device keeper 76. With the handle release device 48 in its second position, the handle release device 48 unlocks the handle 51 from its closed position. In some embodiments, depressing the push button 70 may also allow another device (e.g., a spring, etc.) to at least partially push the handle 51 out from its closed position.

During certain events (e.g., a fan blade out event, fan windmilling, extreme turbulence, etc.), the handle 51 and the handle release device 48 may be subject to relatively large vibrations. In an unlikely event that these vibrations become large and/or periodic enough, it may be possible for the handle release device 48 to inadvertently move (e.g., rattle) into its second position. To prevent an unintended movement of the latch assembly 26 and its handle 51, the latch assembly 26 of FIGS. 6 and 7 is provided with the lock 50. This lock 50 may be configured to secure the handle 51 in its closed position.

Referring to FIGS. 6 and 7, the lock 50 may include a catch 78, a mount 80 (e.g., a bracket), a bolt 82, a lock element 84 (e.g., a lever), a spring 86 (e.g., a coil spring, a compression spring, etc.) and a retainer 88. The catch 78 may be configured as a part of, or a fixture connected to, the handle 51. The catch 78 of FIGS. 6 and 7, for example, is configured as a bolt (e.g., a pin, a rod, a fastener, etc.) extending laterally between two flanges of the handle 51. This catch 78 may be disposed at (e.g., on, adjacent or proximate) a respective longitudinal end 89A, 89B (generally referred to as “89”) of the handle 51, where the handle 51 extends longitudinally between and to the handle first end 89A and the handle second end 89B of the handle 51 (see FIG. 5). Referring to FIG. 6, the mount 80 rotatably attaches the bolt 82 to one of the fittings 54 or 58 or another fixed structure (e.g., frame) of the respective aircraft components 22, 24. However, for ease of description, the catch 78 may be described below as being disposed at the handle first end 89A, and the mount 80 may be described as being mounted to the fitting 54. The bolt 82 (e.g., a pin, a rod, a fastener, etc.) is mated with an aperture 90 in the fitting 54. The bolt 82 of FIG. 6, for example, projects axially along a lock element axis 92 (e.g., a pivot axis) (in a first direction) into the aperture 90 to an exterior distal end 94 of the bolt 82. The bolt 82 projects axially along the axis 92 (in a second direction opposite the first direction) out from the fitting 54, sequentially through apertures in the lock members 80, 84, 86 and 88, to an interior distal end 96 of the bolt 82. The lock element 84 is rotationally fixed to the bolt 82 (e.g., via a keyed interface), but may translate axially along the bolt 82. The retainer 88 is mounted (e.g., fixed to) the bolt 82 at its interior distal end 96.

With the foregoing arrangement, each of the lock members 80, 84, 86 and 88 is mounted onto (and circumscribes) the bolt 82. The lock element 84 is axially between and may engage (e.g., contact, abut against, etc.) the mount 80 and the spring 86. The spring 86 is axially between and may engage the lock element 84 and the retainer 88. The spring 86 may be compressed between the lock element 84 and the retainer 88. The spring 86 may thereby bias (e.g., press) the lock element 84 axially in the first direction against the mount 80 and towards the fitting 54. The spring bias force may be selected to prevent unintentional rotation of the bolt 82 and, thus, the lock element 84 about the axis 92. In other words, the spring bias force may be selected such that the large vibrations discussed above cannot ready disengage the lock 50.

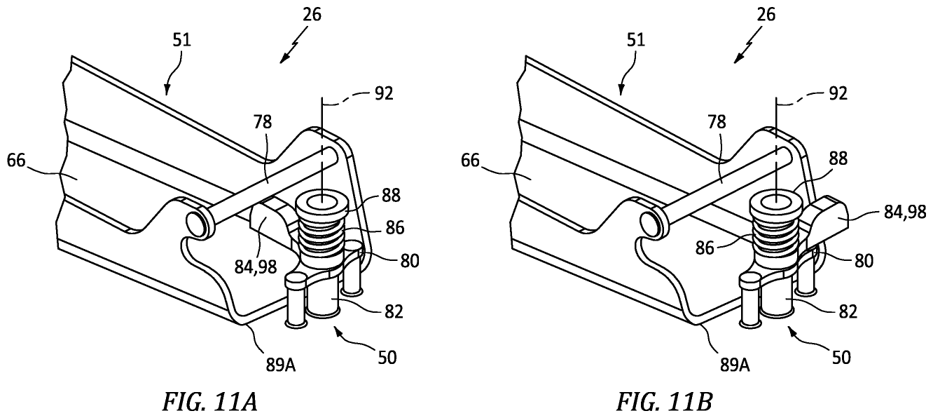

The lock members 82 and 84 may be rotatable about the axis 92 between a locked position (e.g., see FIG. 11A) and an unlocked position (e.g., see FIG. 11B). In the locked position of FIG. 11A, the lock element 84 is aligned with the catch 78/the handle 51. More particularly, an arm 98 of the lock element 84 projects over and overlaps the catch 78. The lock element 84 and its arm 98 may thereby form a stop which prevents movement (e.g., lifting) of the handle 51 out of its closed position. The lock 50 therefore locks the handle 51 in its closed position. By contrast, in the unlocked position of FIG. 11B, the lever arm 98 is misaligned from the catch 78/the handle 51. More particularly, the lever arm 98 is positioned next to (e.g., does not overlap) the catch 78. The lock element 84 and its arm 98 may thereby no longer obstruct movement (e.g., lifting) of the handle 51 out of its closed position. The lock 50 therefore unlocks the handle 51 from its closed position.

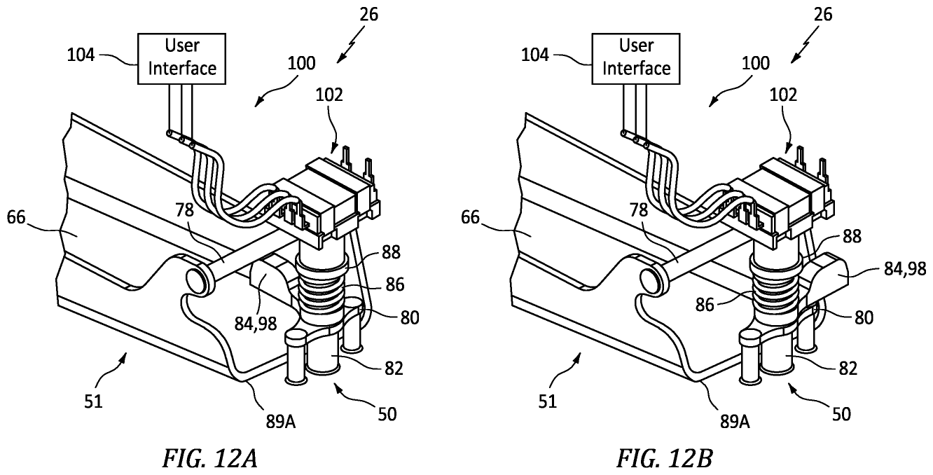

Referring to FIGS. 12A and 12B, the latch assembly 26 is configured with a monitoring system 100 for monitoring a status of the latch assembly 26. The monitoring system 100, for example, may monitor whether the lock 50 is (e.g., completely) locked or (e.g., partially or completely) unlocked.

The monitoring system 100 of FIGS. 12A and 12B includes a lock sensor 102 for the lock 50 and a user interface 104 (e.g., a display screen, an indicator light, a speaker, etc.) and/or another computing device in signal communication with the lock sensor 102. The lock sensor 102 may be configured to monitor whether the lock element 84 and its arm 98 are in the locked position (see FIG. 12A) or the unlocked position (see FIG. 12B), or optionally an intermediate position between the locked position and the unlocked position. The lock sensor 102 of FIGS. 12A and 12B, for example, is configured as an electronic sensor such as a rotary sensor. This lock sensor 102 may be rotationally coupled to the bolt 82 such that the lock sensor 102 may determine a rotational position of the bolt 82 and, thus, the lock element 84 and its arm 98 about the axis 92 (see FIGS. 11A and 11B). When the lock element 84 and its arm 98 are in the locked position, the lock sensor 102 may provide a lock signal, and the user interface 104 may present a lock indicator (e.g., visual and/or audible alert) to a user; e.g., the user within a cockpit of the aircraft. In addition or alternatively, when the lock element 84 and its arm 98 are in the unlocked position, the lock sensor 102 may provide an unlock signal, and the user interface 104 may present an unlock indicator (e.g., visual and/or audible alert) to the user. In this manner, a pilot may confirm whether or not the aircraft components 22, 24 have been properly secured for flight without requiring, for example, a visual inspection.

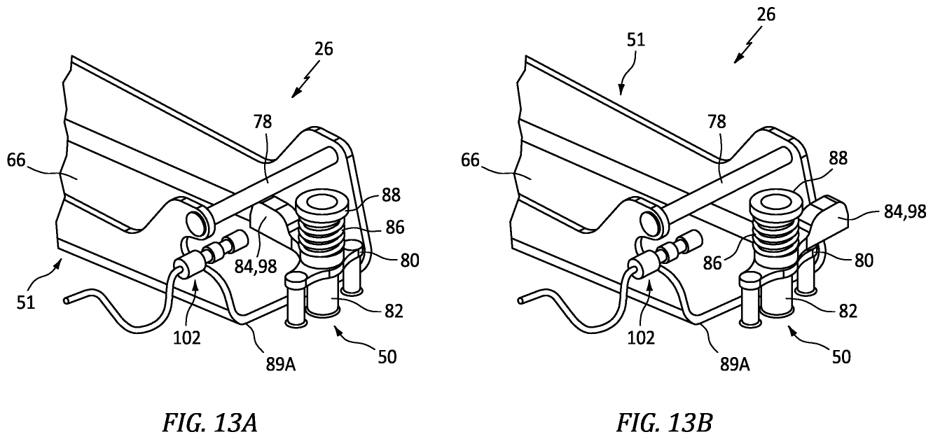

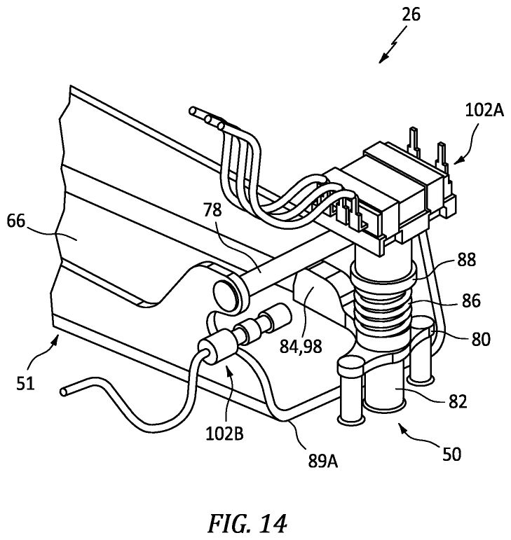

In some embodiments, referring to FIGS. 12A and 12B, the lock sensor 102 may be configured as the rotary sensor. In other embodiments, referring to FIGS. 13A and 13B, the lock sensor 102 may alternatively be configured as an electronic sensor such as a proximity sensor. With such a configuration, the lock sensor 102 may determine the lock 50 is locked when the lock element 84 and its arm 98 are, for example, close to the lock sensor 102. By contrast, the lock sensor 102 may determine the lock 50 is unlocked when the lock element 84 and its arm 98 are, for example, far from the lock sensor 102 (or not detectable by the lock sensor 102). In still other embodiments, referring to FIG. 14, the monitoring system 100 may include multiple lock sensors 102A and 102B (generally referred to as “102”) for redundancy. These lock sensors 102 may be configured as different types of electronic sensors. The first lock sensor 102A, for example, may be configured as a rotary sensor and the second lock sensor 102B may be configured as a proximity sensor; however, the present disclosure is not limited to such exemplary lock sensors.

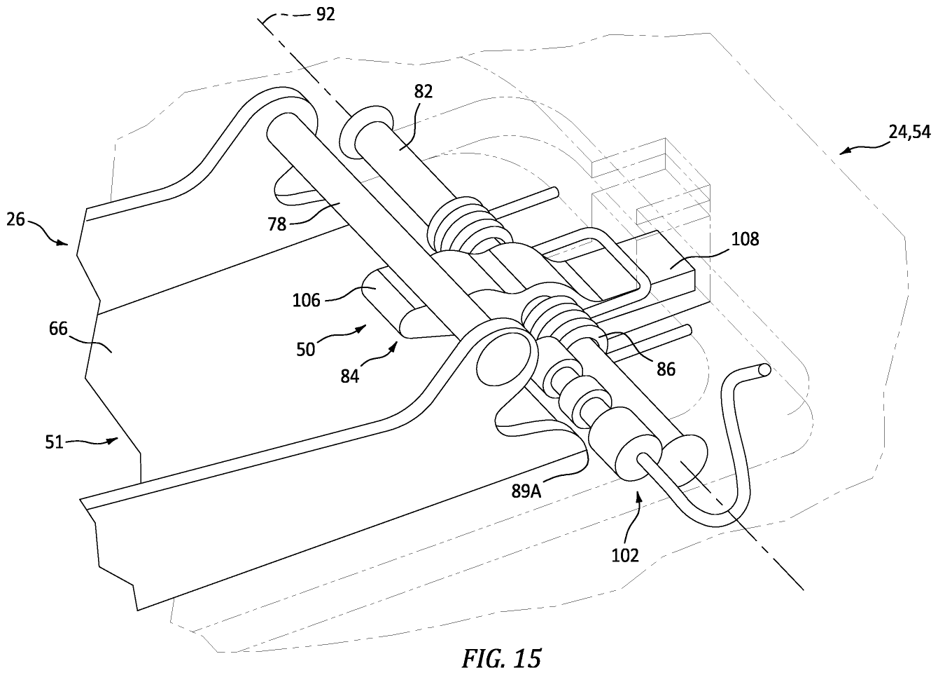

In some embodiments, the lock 50 may be configured such that its axis 92 (see FIG. 6) is angularly offset from (e.g., perpendicular to) the axis 61 of the latch 46 (see FIGS. 1 and 5). In other embodiments, the lock 50 may be configured such that its axis 92 (see FIG. 15) is parallel with the axis 61 of the latch 46 (see FIGS. 1 and 5). In the specific embodiment of FIG. 15, when the lock 50 is locked, a first end 106 of the lock element 84 (e.g., the lever) is configured to engage (e.g., contact) the catch 78 and a second end 108 of the lock element 84 is configured to engage (e.g., contact) a land of the fitting 54. When the lock 50 is unlocked, the lock element 84 may be pivoted about its axis 92 (e.g., the first end 106 may move inward (up in FIG. 15) and the second end 108 may move outwards (down in FIG. 15)) such that the catch 78 may move past the lock element 84 facilitating opening of the latch 46 and its handle 51.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An assembly for an aircraft, comprising:
a keeper;
a latch including a handle and a hook structure operatively coupled to the handle, the handle configured to move between a closed position and an open position, the hook structure engaged with the keeper when the handle is in the closed position, and the hook structure disengaged from the keeper when the handle is in the open position;
a lock comprising a lock element configured to move between a locked position and an unlocked position, the lock configured to lock the handle in the closed position when the lock element is in the locked position, and the lock configured to unlock the handle from the closed position when the lock element is in the unlocked position; and
an electronic sensor configured to provide a signal when the lock element is in one of the locked position or the unlocked position.

2. The assembly of claim 1, wherein the electronic sensor is configured to provide the signal when the lock element is in the locked position.

3. The assembly of claim 1, wherein the electronic sensor is configured to provide the signal when the lock element is in the unlocked position.

4. The assembly of claim 1, wherein the electronic sensor comprises a rotary sensor.

5. The assembly of claim 1, wherein the electronic sensor comprises a proximity sensor.

6. The assembly of claim 1, further comprising a second electronic sensor configured to provide a second signal when the lock element is in one of the locked position or the unlocked position.

7. The assembly of claim 6, wherein the electronic sensor and the second electronic sensor are different types of sensors.

8. The assembly of claim 6, wherein
the electronic sensor comprises a rotary sensor; and
the second electronic sensor comprises a proximity sensor.

9. The assembly of claim 1, further comprising a user interface configured to present an indicator when the electronic sensor provides the signal.

10. The assembly of claim 1, wherein the lock element comprises a lever.

11. The assembly of claim 1, wherein
the lock further comprises a catch;
the lock element is aligned with the catch locking the handle in the closed position when the lock element is in the locked position; and
the lock element is misaligned from the catch unlocking the handle from the closed position when the lock element is in the unlocked position.

12. The assembly of claim 1, wherein the lock element is configured to rotate about a lock element axis between the locked position and the unlocked position.

13. The assembly of claim 12, further comprising:
a fitting adjacent the handle;
the lock further including a bolt rotatably mounted to the fitting; and
the lock element rotationally fixed to the bolt.

14. The assembly of claim 12, wherein
the latch is configured to pivot about a latch axis between the closed position and the open position; and
the latch axis is angularly offset from the lock element axis.

15. The assembly of claim 12, wherein
the latch is configured to pivot about a latch axis between the closed position and the open position; and
the latch axis is parallel with the lock element axis.

16. The assembly of claim 1, wherein
the handle extends longitudinally between a first end and a second end; and
the lock is arranged at the first end.

17. The assembly of claim 1, further comprising:
a fixed structure;
a first aircraft component pivotally attached to the fixed structure, the latch mounted to the first aircraft component; and
a second aircraft component pivotally attached to the fixed structure, the keeper mounted to the second aircraft component.

18. The assembly of claim 1, further comprising:
a fitting adjacent the handle, the fitting comprising a land;
the lock further comprising a catch;
the lock element extending between a first end and a second end;
the lock element configured to engage the catch at the first end and the lock element configured to engage the land at the second end when the lock is in the locked position; and
the lock element configured to pivot about an axis moving the first end inwards and moving the second end outwards when the lock is moved from the locked position to the unlocked position, wherein the catch is configured to move past the lock element facilitating opening of the latch when the lock is in the unlocked position.

19. An assembly for an aircraft, comprising:
a keeper;
a latch including a handle and a hook structure operatively coupled to the handle, the handle configured to move between a closed position and an open position, the hook structure engaged with the keeper when the handle is in the closed position, and the hook structure disengaged from the keeper when the handle is in the open position;
a lock comprising a lock element configured to move between a locked position and an unlocked position, the lock configured to lock the latch when the lock element is in the locked position, and the lock configured to unlock the latch when the lock element is in the unlocked position; and
a rotary sensor configured to provide a signal when the lock element is in one of the locked position or the unlocked position.

20. An assembly for an aircraft, comprising:
a keeper;
a latch including a handle and a hook structure operatively coupled to the handle, the handle configured to move between a closed position and an open position, the hook structure engaged with the keeper when the handle is in the closed position, and the hook structure disengaged from the keeper when the handle is in the open position;
a lock comprising a lock element configured to move between a locked position and an unlocked position, the lock configured to lock the latch when the lock element is in the locked position, and the lock configured to unlock the latch when the lock element is in the unlocked position; and
a proximity sensor configured to provide a signal when the lock element is in one of the locked position or the unlocked position.
